(19) United States
(12) Patent Application Publication
(10) Pub. No.: US 2019/0389367 A1
(43) Pub. Date: Dec. 26, 2019

(54) BACKUP MARKER LIGHTS FOR COMMERCIAL TRUCKS AND TRAILERS

(71) Applicant: James Wesley McHenry, Southport, NC (US)

(72) Inventor: James Wesley McHenry, Southport, NC (US)

(21) Appl. No.: 16/210,627

(22) Filed: Dec. 5, 2018

Related U.S. Application Data
(60) Provisional application No. 62/687,982, filed on Jun. 21, 2018.

(51) Int. Cl. B60Q 1/22; B60Q 1/00; F21S 43/14; B62D 63/08

(52) U.S. Cl. CPC B60Q 1/22; B60Q 1/0035; F21Y 2115/10; B62D 63/08; F21S 43/14

(57) ABSTRACT

A lighting system of a trailer. A rear end of the trailer includes a top edge, a bottom edge opposite the top edge, and side edges. At least one marker light is coupled to the top edge of the rear end of the trailer. The marker light is electrically coupled to an electrical system of a truck so that the marker light is activated when the truck is engaged in reverse.

### CROSS-REFERENCE TO RELATED APPLICATION

This application claims the benefit of priority of U.S. provisional application No. 62/687,982, filed Jun. 21, 2018, the contents of which are herein incorporated by reference.

### BACKGROUND OF THE INVENTION

The present invention relates to back up marker lights for commercial trailers.

Currently, there is no visual mechanism that produces a warning to the public when semi-trucks and trailers are backing up.

As can be seen, there is a need for back up marker lights for commercial trailers.

### SUMMARY OF THE INVENTION

In one aspect of the present invention, a lighting system of a trailer comprises: a rear end of the trailer having a top edge, a bottom edge opposite the top edge, and side edges; and at least one marker light coupled to the top edge of the rear end of the trailer, wherein the at least one marker light is electrically coupled to an electrical system of a truck so that the at least one marker light is activated when the truck is engaged in reverse.

These and other features, aspects and advantages of the present invention will become better understood with reference to the following drawings, description and claims.

### BRIEF DESCRIPTION OF THE DRAWINGS

FIG. 1 is a rear elevation view of an embodiment of the present invention in use;

FIG. 2 is a detail elevation view indicated by line 2-2 in FIG. 1; and

FIG. 3 is a detail cross-sectional view taken along line 3-3 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes backup marker lights for commercial trailers. In certain embodiments, the present invention includes three middle marker lights that flash white or clear light emitting diodes (LEDs). By using the marker lights, the high clearance flashers warn not only one car behind the truck but also warns several cars back and all surroundings with any persons walking near or about to walk behind the trailer.

The present invention is used to identify when the trailer is backing up by warning anyone or vehicles at the rear of the trailer. The height of the marker lights allows more visibility than any low four-way flashing lights that are now in operation. The four-way flashers currently do not warn of backing up. The present invention may be used with self-driving vehicles or man driven vehicles.

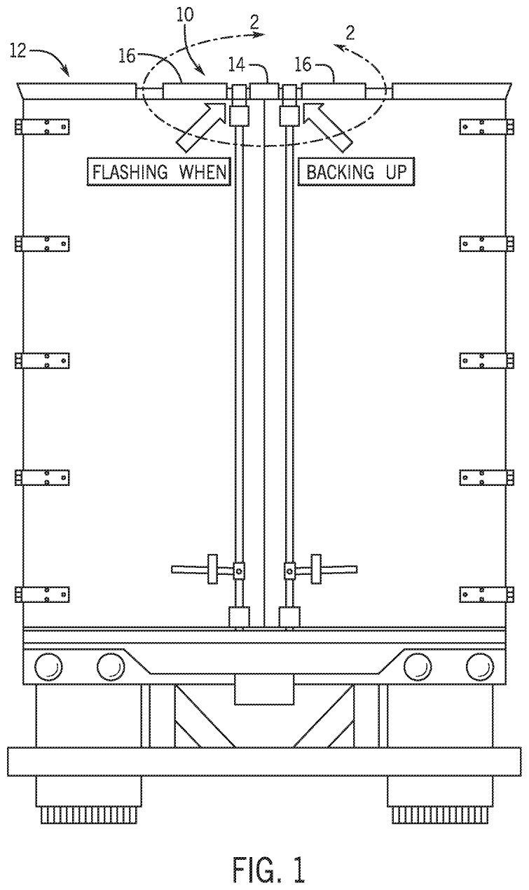

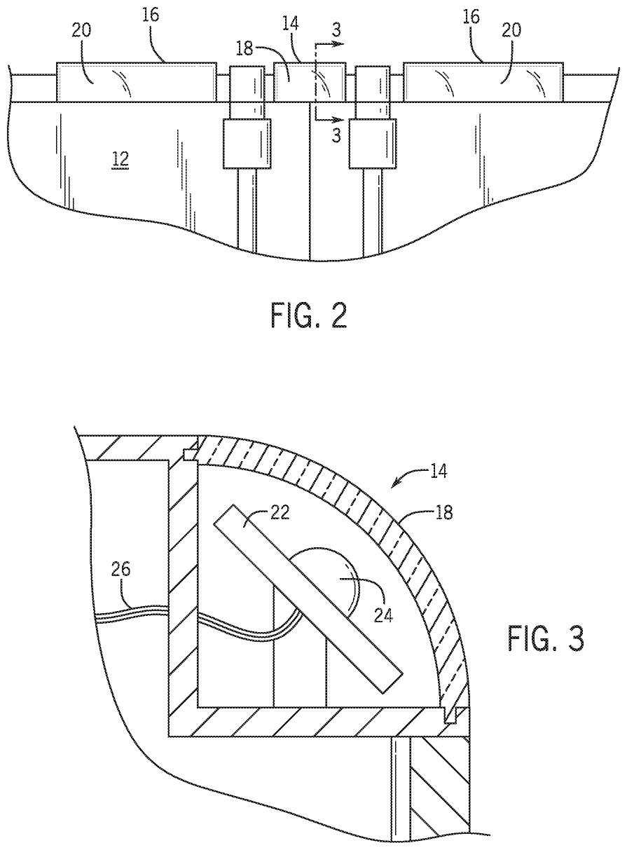

Referring to FIGS. 1 through 3, the present invention includes a lighting system of a trailer 12. The trailer 12 is coupled to a truck having an engine, wheels driven by the engine, an electrical system, and a cabin. The trailer includes a front end that couples to the truck, a rear end, a top, a bottom, wheels coupled to the bottom, and electrical wiring 26. The rear end of the trailer 12 includes a top edge, a bottom edge opposite the top edge, and side edges. The bottom edge is closest to the wheels of the trailer 12. At least one marker light 10 is coupled to the top edge of the rear end of the trailer 12. The marker light 10 is electrically coupled the electrical wiring 26 which is electrically coupled to the electrical system of the truck so that the marker light 10 is activated when the truck 12 is engaged in reverse. The marker light 10 may be activated manually by a switch disposed within the cabin or the marker light 10 may be activated automatically when the truck 12 is shifted into reverse.

In certain embodiments, the at least one marker light 10 may include an inner marker light 14 coupled to a central portion of the top edge, and a first outer marker light 16 and a second outer marker light 16 coupled to the top edge on either side of the inner marker light. The trailer 12 may further include indicia that indicate that the trailer 12 is in reverse when the marker lights 10 are turned on.

In certain embodiments, the marker lights 10 are a colored light or a white light. The outer marker lights 16 may include at least one of a colored bulb 24 and a colored translucent light diffuser 20. The inner marker light 14 may include at least one of a colored bulb 24 and a colored translucent light diffuser 18. Each of the marker lights 16 may further include a mounting unit 22, a bulb 24 coupled to the mounting unit 22, and the electrical wiring 26 electrically connecting the bulb 24 to the electrical system of the truck.

It should be understood, of course, that the foregoing relates to exemplary embodiments of the invention and that modifications may be made without departing from the spirit and scope of the invention as set forth in the following claims.

1. A lighting system of a trailer comprising:
a rear end of the trailer having a top edge, a bottom edge opposite the top edge, and side edges; and
at least one marker light coupled to the top edge of the rear end of the trailer, wherein
the at least one marker light is electrically coupled to an electrical system of a truck so that the at least one marker light is activated when the truck is engaged in reverse.

2. The lighting system of claim 1, wherein the at least one marker light is an inner marker light coupled to a central portion of the top edge, and a first outer marker light and a second outer marker light coupled to the top edge on either side of the inner marker light.

3. The lighting system of claim 1, wherein the at least one marker light is a colored light or a white light.

4. The lighting system of claim 3, wherein the colored light comprises at least one of a colored bulb and a colored translucent light diffuser.

5. The light system of claim 1, wherein the at least one marker light comprises a mounting unit, a bulb coupled to the mounting unit, and an electrical wiring electrically connecting the bulb to the electrical system of the truck.
